(19) United States
(12) Patent Application Publication
(10) Pub. No.: US 2026/0121351 A1
(43) Pub. Date: Apr. 30, 2026

(54) ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAOZHE ZI, Irvine, CA (US); TERRANCE F. LITTLE, Fullerton, CA (US); AN-JEN YANG, Irvine, CA (US)

(21) Appl. No.: 18/925,952

(22) Filed: Oct. 24, 2024

(51) Int. Cl. H01R 13/6471; H01R 12/71; H01R 13/6594

(52) U.S. Cl. CPC H01R 13/6471; H01R 12/716; H01R 13/6594

(57) ABSTRACT

An electrical connector assembly includes: an insulative housing having a front mating slot and a rear receiving space; a terminal module received in the insulative housing and including plural terminals arranged in a transverse direction, each terminal including a mating portion and a tail portion; a cable electrically connected to the terminal module; and an intermediate conductor, wherein the plural terminals include a high-speed terminal area and a sideband terminal area, the terminals in the high-speed terminal area include plural ground terminals and signal terminal pairs arranged between adjacent ground terminals, the cable includes a pairs of inner conductor, and the pairs of inner conductor are electrically connected to the tail portions of a corresponding pair of signal terminals through the intermediate conductor.

### BACKGROUND OF THE INVENTION

### Field of the Invention

The present invention relates generally to an electrical connector assembly, and particularly to an electrical connector assembly suitable for transmitting high-speed signals in communication infrastructure fields such as servers and switches.

### Description of Related Arts

China Patent Application Publication No. CN114976724A discloses an electrical connector assembly comprising an insulating housing, a terminal module received in the insulating hosing, and a cable connected to the terminal module. The terminals of the terminal module are directly connected to the cable, which makes the impedance between the cable and the terminal difficult to control and adjust.

An improved electrical connector assembly is desired.

### SUMMARY OF THE INVENTION

The objective of the present invention is to provide an electrical connector assembly having a terminal module with good impedance matching characteristics.

To achieve the above object, an electrical connector assembly comprises: an insulative housing having a front mating slot and a rear receiving space; a terminal module received in the insulative housing, the terminal module includes a plurality of terminals arranged in a transverse direction, each of the plurality of terminals including a mating portion and a tail portion; a cable electrically connected to the terminal module and extending backward out of the insulative housing; and an intermediate conductor connecting the terminal module and the cable; wherein the plurality of terminals includes a high-speed terminal area and a sideband terminal area, the terminals in the high-speed terminal area include a plurality of ground terminals and signal terminal pairs arranged between adjacent ground terminals, the cable includes pairs of signal core wires and a shielding layer covering each pair of signal core wires, each of the signal core wires includes an inner conductor and an inner insulation layer covering the inner conductor, and the inner conductors of a pair of signal core wires are electrically connected to the tail portions of a corresponding pair of signal terminals through the intermediate conductor.

To achieve the above object, an electrical connector assembly comprises: an insulative housing having a front mating slot and a rear receiving space; an upper terminal module including a first row of terminals arranged in a transverse direction; a lower terminal module including a second row of terminals arranged along the transverse direction; a cable electrically connected to the upper terminal module and the lower terminal module; and an intermediate circuit board; wherein each terminal of the first row of terminals and the second row of terminals includes a mating portion and a tail portion, the mating portions of the first row of terminals and the second row of terminals are respectively arranged on the upper and lower sides of the mating slot to cooperate with a mating connector, each of the first row of terminals and the second row of terminals includes a plurality of ground terminals and signal terminal pairs arranged between adjacent ground terminals, the cable includes a pair of spaced apart inner conductors and an inner insulation layer covering the inner conductors, and the tail portions of a signal terminal pairs and the front end of the pair of inner conductor are both mechanically and electrically connected to the circuit board.

Compared to prior art, in the electrical connector assembly of the present invention, terminal modules and cables are transferred through the intermediate conductor, so that there is space for optimizing SI between the cable and terminal module.

### BRIEF DESCRIPTION OF THE DRAWING

FIG. 1 is a perspective view of an electrical connector assembly according to the present invention;

FIG. 2 is another perspective view of the electrical connector assembly of FIG. 1;

FIG. 3 is an exploded view of the electrical connector assembly of FIG. 1;

FIG. 4 is another exploded view of the electrical connector assembly of FIG. 3;

FIG. 5 is an exploded view of the electrical connector assembly of FIG. 3 without showing the insulative housing;

FIG. 6 is another exploded view of the electrical connector assembly of FIG. 3 without showing the insulative housing;

FIG. 7 is a further exploded view of the electrical connector assembly of FIG. 5;

FIG. 8 is another exploded p view of the electrical connector assembly of FIG. 7;

FIG. 9 is a perspective view of the upper terminal module of the electrical connector assembly of FIG. 5 and the cable connected thereto;

FIG. 10 is a perspective view of the lower terminal module of the electrical connector assembly of FIG. 5 and the cable connected thereto;

FIG. 11 is a perspective view of the upper terminal module of FIG. 9 and the cable connected to it without the transfer terminals;

FIG. 12 is an exploded view of the upper terminal module of FIG. 11 and the cable connected to it without the transfer terminals;

FIG. 13 is a further view of the upper terminal module of FIG. 12 and the cable connected to it without the transfer terminals;

FIG. 14 a perspective view of the transfer terminal, mounting member and positioning member of the upper terminal module of FIG. 9, before they are assembled;

FIG. 15 a perspective view of the transfer terminal, mounting member and positioning member of the upper terminal module of FIG. 14, before they are assembled;

FIG. 16 is an exploded view of the transfer terminal, mounting member and positioning member of the upper terminal module of FIG. 15, before they are assembled;

FIG. 17 is a perspective view of the transfer terminals and mounting member of the lower terminal module of FIG. 10;

FIG. 18 is a cross-sectional view taken along line 18-18 of the electrical connector assembly of FIG. 1;

FIG. 19 is a cross-sectional view taken along line 19-19 of the electrical connector assembly of FIG. 1;

FIG. 20 is a cross-sectional view taken along line 20-20 of the electrical connector assembly of FIG. 1;

FIG. 21 is a cross-sectional view taken along line 20-20 of the upper terminal module of FIG. 9;

FIG. 22 is a perspective view of another embodiment of a partial structure of the terminal module;

FIG. 23 is a perspective view of the upper terminal module of the terminal module of FIG. 22;

FIG. 24 is another perspective view the upper terminal module of FIG. 23;

FIG. 25 is an exploded view of the upper terminal module of FIG. 23; and

FIG. 26 is another exploded view of the upper terminal module of FIG. 25.

### DETAILED DESCRIPTION OF THE PREFERRED EMBODIMENT

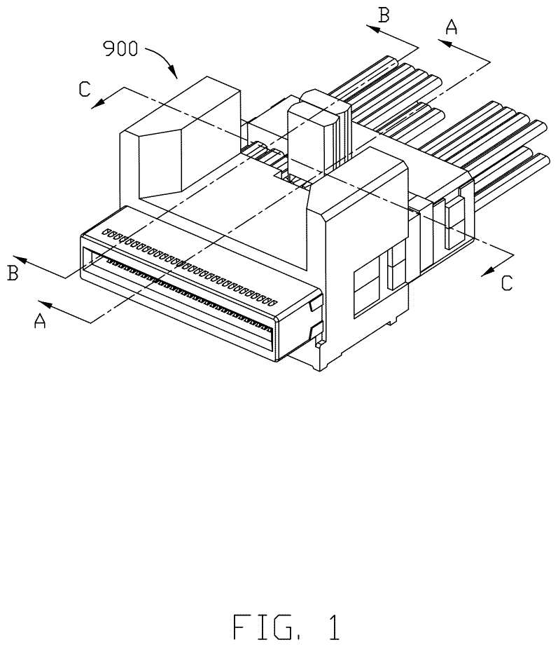

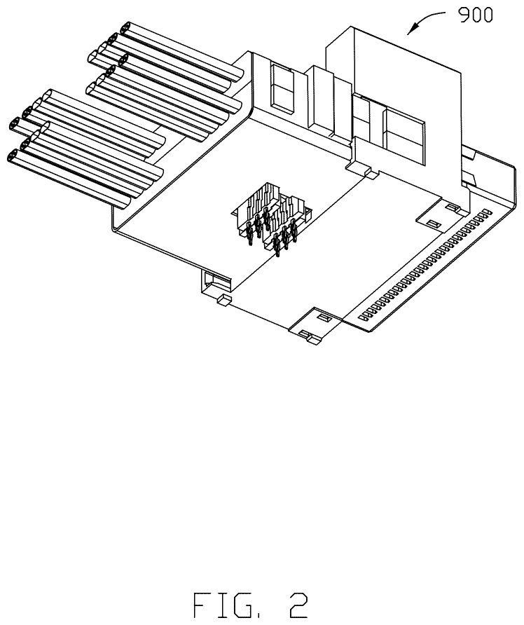

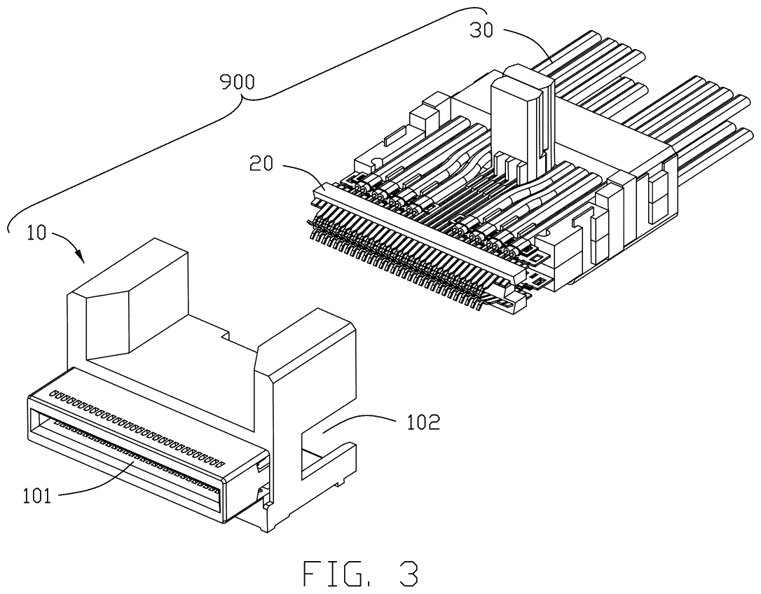

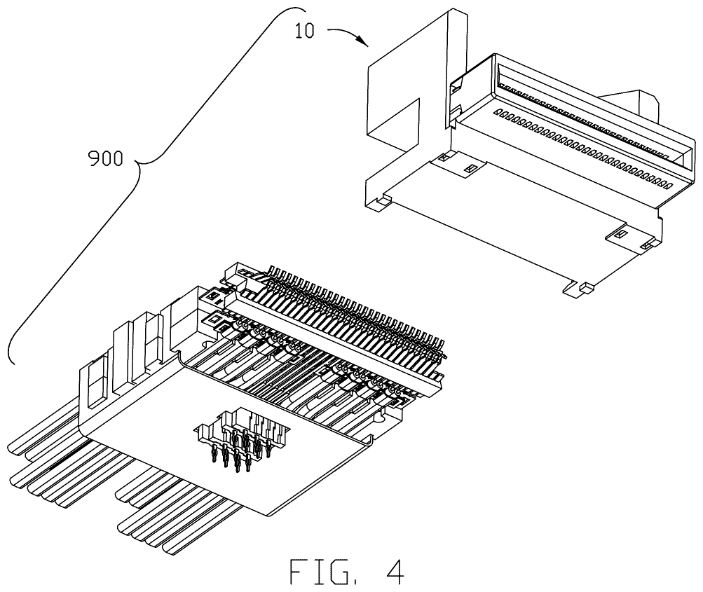

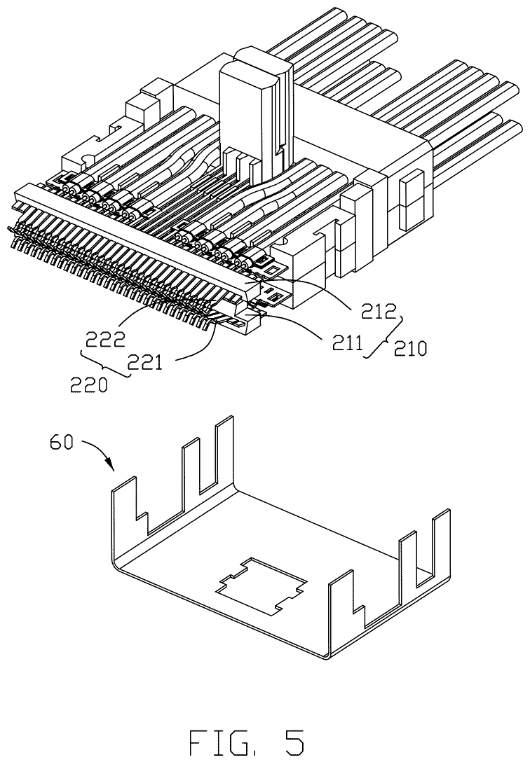

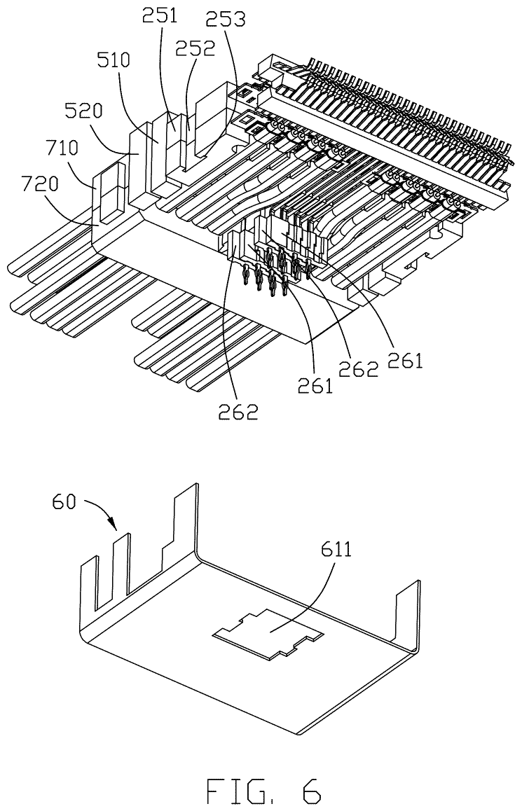

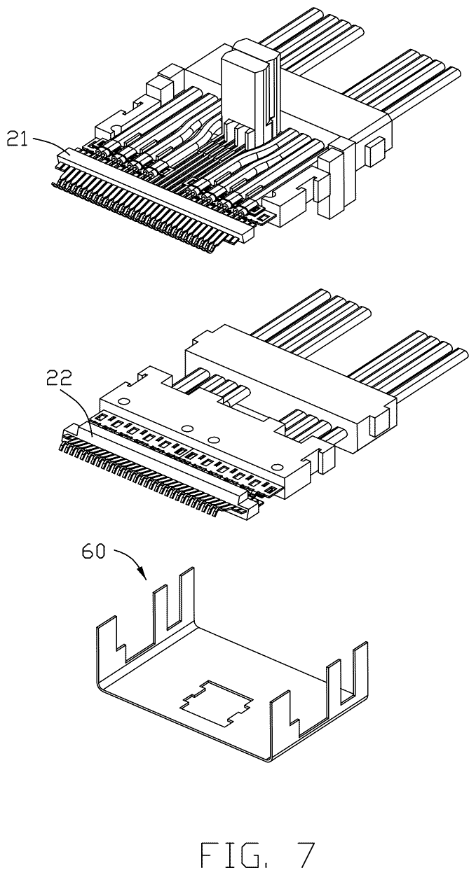

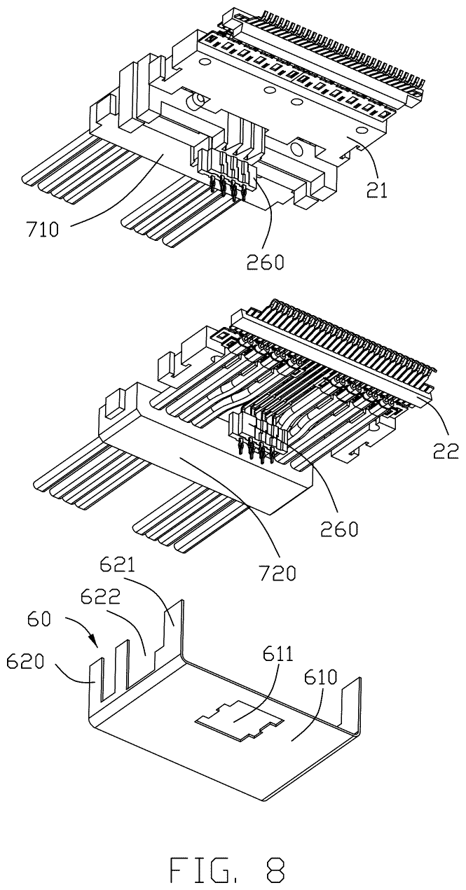

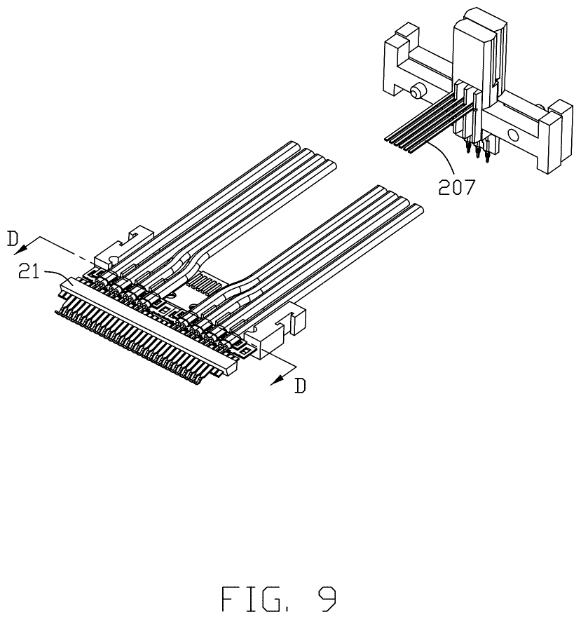

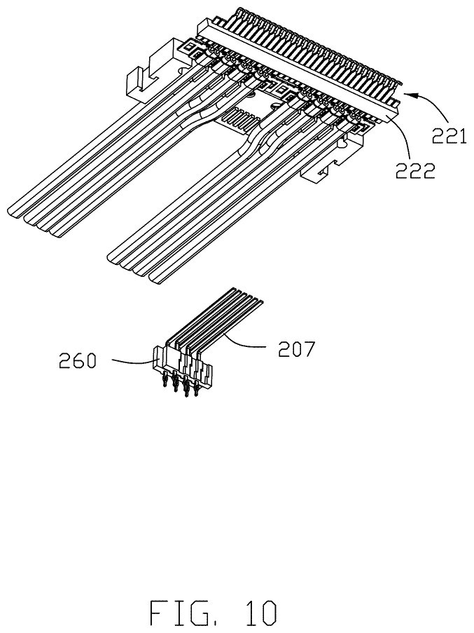

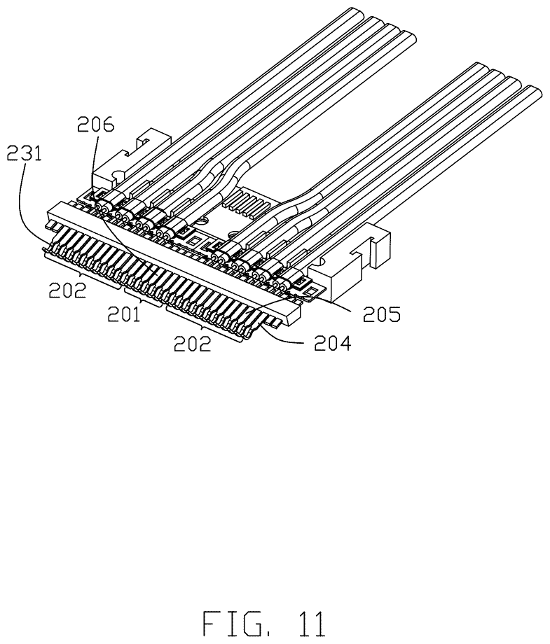

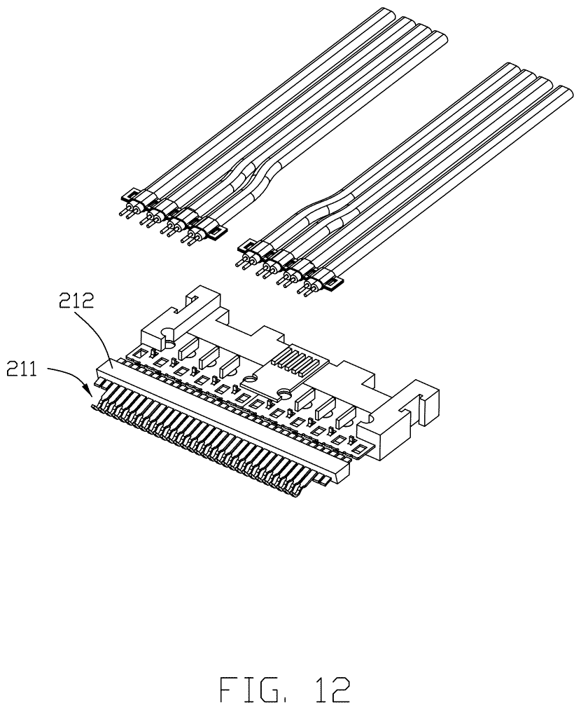

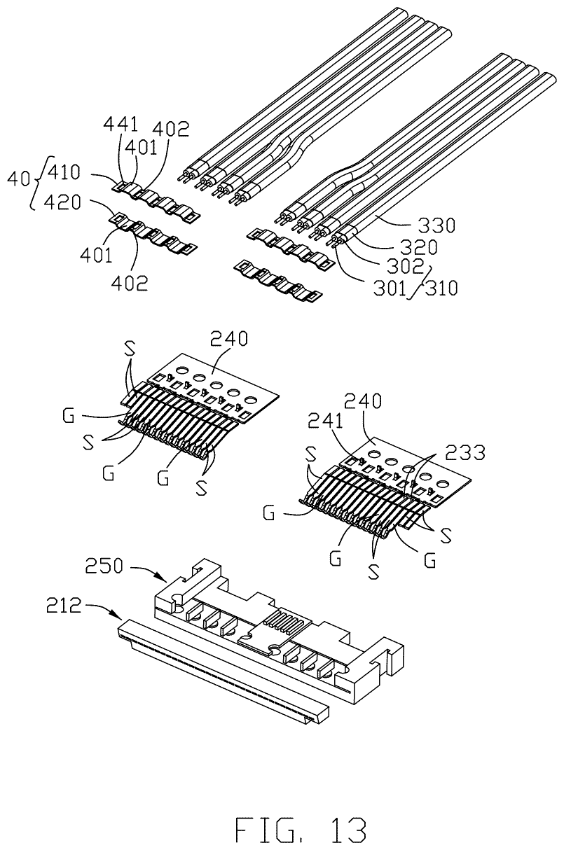

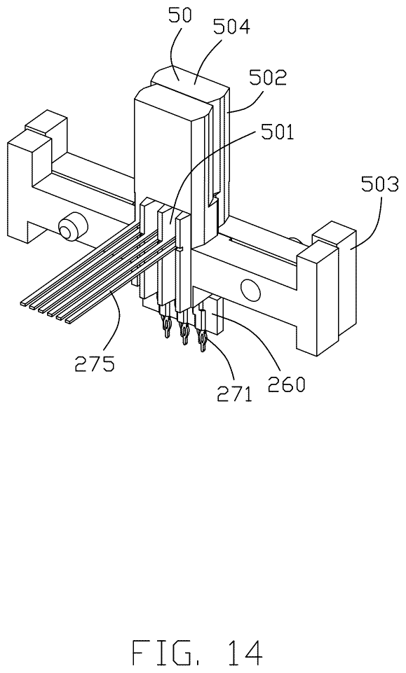

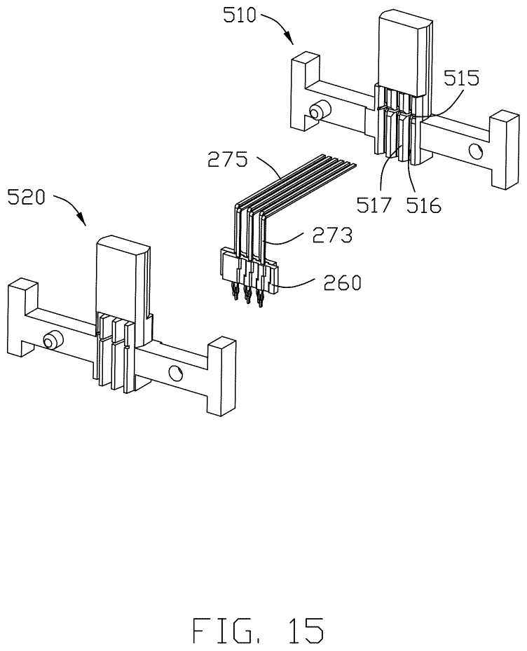

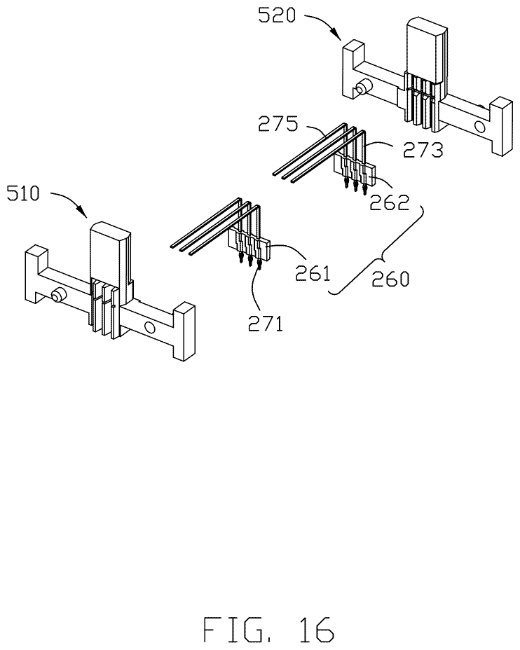

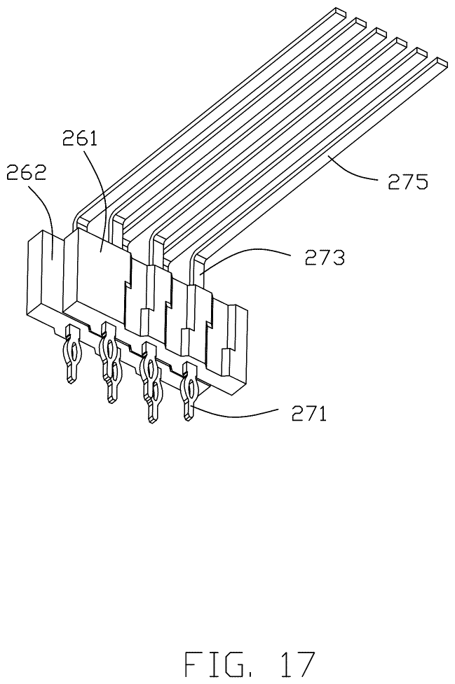

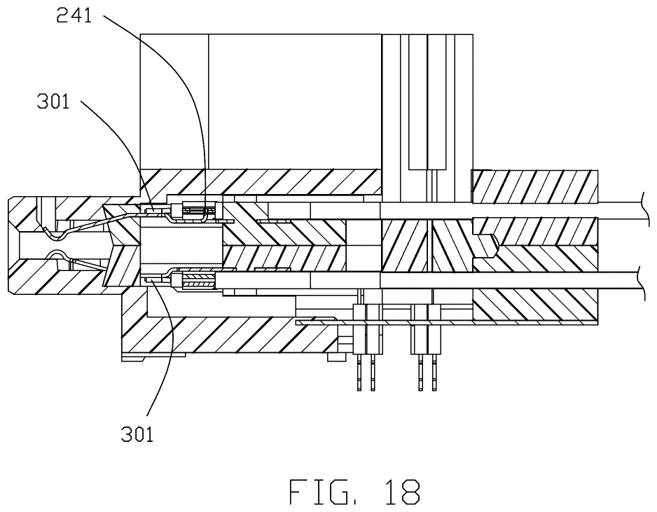

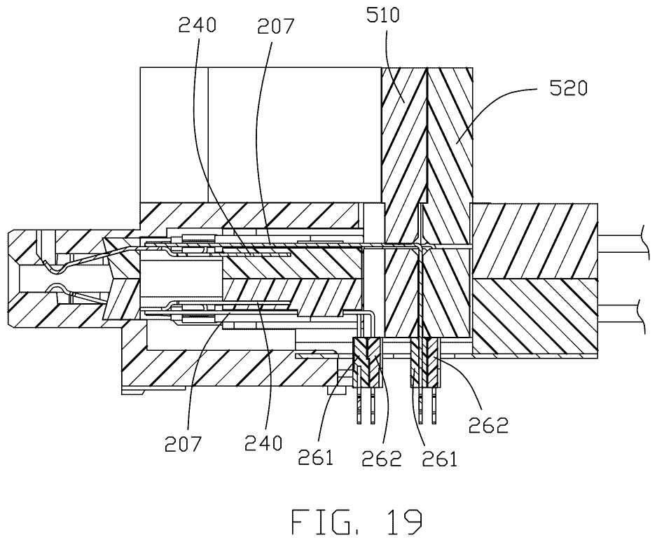

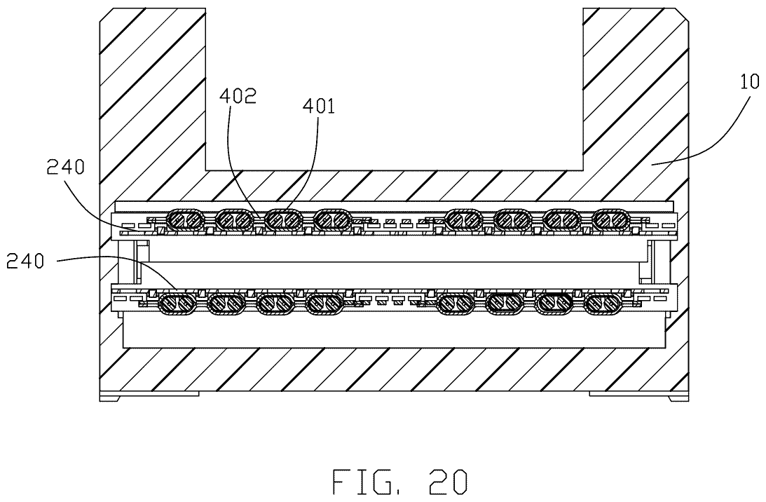

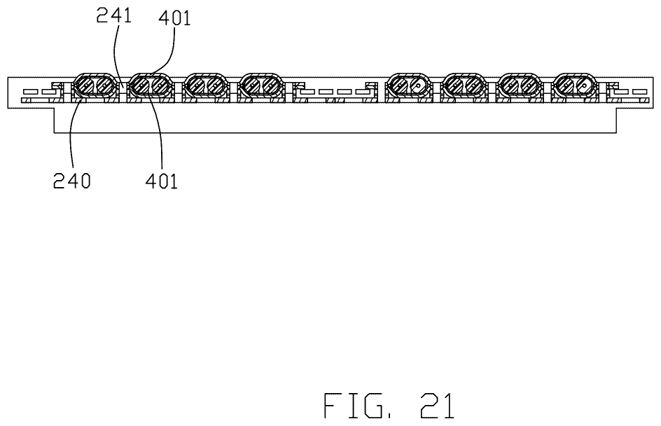

Referring to FIGS. 1-21, an electrical connector assembly 900 in accordance with the present invention is shown. The electrical connector assembly 900 can be installed on an external circuit board and can be matched with a mating connector (not shown) along a front-to-back direction

The electrical connector assembly 900 comprises an insulative housing 10, a terminal module 20 received in the insulative housing 10, and a cable 30 electrically connected to the terminal module 20 and extending backward out of the insulative housing 10. The housing 10 has a front mating slot 101 and a rear receiving space 102. The terminal module 20 includes an upper terminal module 21 and a lower terminal module 22 stacked with each other in the vertical direction. The front ends of the upper terminal module 21 and the lower terminal module 22 form a mating area for mating with the two sides of the circuit board of the mating connector.

The upper terminal module 21 includes a first terminal module 210, the lower terminal module includes a second terminal module 220. The first terminal module 210 and the second terminal module 220 are spaced apart in the vertical direction. The first terminal module 210 includes a first row of terminals 211 arranged in a transverse direction perpendicular to the vertical direction and a first insulating member 212 fixed on the first row of terminals 211. The second terminal module 220 includes a second row of terminals 221 arranged along the transverse direction and a second insulating member 222 fixed on the second row of terminals 221. The first insulating member 212 and the second insulating member 222 are integrally formed on the corresponding row of terminals. The structures of the first terminal module 210 and the second terminal module 220 are exactly the same.

Each of the first row of terminals 211 and the second row of terminals 221 include a high-speed terminal area 202 and a sideband terminal area 202. The sideband terminal area 201 is arranged in the middle area, and the high-speed terminal area 202 is arranged on the two sides of the sideband terminal area 201. The terminals of the high-speed terminal area 202 include ground terminals 204 and signal terminal pairs 205 arranged alternately with the ground terminals 204 in the transverse direction. Each of the high-speed terminal areas 202 has at least three pairs of signal terminals 205. Specifically, in the present invention, each of the high-speed terminal areas 202 has four pairs of signal terminal 205. The sideband terminal area 201 includes a plurality of sideband terminals 206. Each of the sideband terminals 206, the signal terminal 205 and the ground terminal 204 includes a mating portion 231 at the front for mating with the circuit board of the mating connector and a tail portion 233 at the rear. The mating portions 231 of each terminal of the first row of terminals 211 are arranged in a row in the transverse direction and are located on the upper side of the front mating slot 101. The mating portions 231 of each terminal of the second row of terminals 221 are arranged in a row along the transverse direction and are located on the lower side of the front mating slot 101.

Each of the upper terminal module 21 and the lower terminal module 22 further include a plurality of transfer terminals 207. Each of the transfer terminal 207 is mechanically and electrically connected to the corresponding sideband terminal 206. Each of the transfer terminals 207 includes a mounting foot 271 that can be mounted on the external circuit board, a vertical portion 273 extending upward from the mounting foot 271, and a horizontal portion 275 extending forward from the vertical portion 273. The mounting feet 271 are fish-eye-shaped and can be directly pressed on the external circuit board. The sideband terminals 206 of the first row of terminals 211 and the corresponding transfer terminals 207 together form the upper circuit board mounting terminals of the upper terminal module 21. Similarly, the transfer terminal 207 and the corresponding sideband terminal 206 of the second row of terminals 221 together form the lower circuit board mounting terminal of the lower terminal module 22. The front end of the horizontal portion 275 of each transfer terminal 207 is soldered to the tail portion 233 of the corresponding sideband terminal 206.

The terminal module 20 further includes positioning members 260 respectively provided on the corresponding transfer terminals 207. The horizontal portions 275 of the upper circuit board mounting terminals are arranged in one row along the transverse direction, and the vertical portions 273 are arranged in two rows at the front and rear. The positioning member 260 is provided on the vertical portion 273. The positioning member 260 include a front positioning member 261 provided on the front row vertical part 273 and a rear positioning member 262 on the rear row vertical part. The front positioning member 261 is integrally formed on the vertical portion 273 of the front row. The rear positioning member 262 is integrally formed on the vertical portion 273 of the rear row. The front and rear positioning members are assembled and matched together. Similarly, the horizontal portions 275 of the lower circuit board mounting terminals are arranged in one row along the transverse direction, and the vertical portions 273 are arranged in two rows at the front and rear. The vertical parts of the front row and the rear row are also respectively provided with front positioning parts 261 and rear positioning parts 262. The difference is that the dimensions of the horizontal portion 275 and the vertical portion 273 of the upper circuit board mounting terminal are both larger than that of the lower circuit board mounting terminal.

Each of the upper terminal module 21 and the lower terminal module 22 further include a connecting portion 240 provided on the rear side of the tail portion and a rear insulator 250 integrally formed on the connecting portion 240. The connecting portion 240 is mechanically and electrically connected to the corresponding ground terminal 204 of the high-speed terminal area 202. Specifically, in the present invention, all the ground terminals 204 in the corresponding high-speed terminal area 202 are mechanically and electrically connected to the connecting portion 240.

The cable 30 is mechanically and electrically connected to the rear of the high-speed terminal area 202. The cable 30 includes a pair of signal core wires 310 that are mechanically and electrically connected to the corresponding pair of signal terminals 205, a shielding layer 320 provided outside the pair of signal core wires 310, and an insulation layer 330 covering the shielding layer 320. The signal core wire pair 310 includes a pair of inner conductors 301 and an inner insulation layer 302 covering each of the inner conductors 301. The pair of inner conductors 301 are soldered to the tail portions 233 of the corresponding signal terminal pairs 205. The tail portion 233 of the ground terminal 204 is integrally connected to the connecting portion 240 and is electrically connected to the shielding layer 320.

The electrical connector assembly 900 further includes a grounding member 40. The grounding member 40 is located on one side of the connecting portion 240 in the vertical direction and is directly mechanically and electrically connected to the connecting portion 240. Each of the high-speed terminal areas 202 has an independent grounding member 40. The grounding member 40 surrounds each of the signal core wire pairs 310 and is mechanically and electrically connected to the corresponding shielding layer 320. The grounding member 40 includes four independently arranged. The grounding member 40 includes shielding areas surrounding the signal core wire pair 310 and connection areas connecting the adjacent shielding areas. The grounding member 40 includes a first part 410 or an upper grounding part and a second part 420 or a lower grounding part that cooperates with the first part 410. Each of the first part 410 and the second part 420 include a plurality of raised portions 401 and a flat portion 402 connecting the adjacent raised portions 401. The raised portions 401 of the first part 410 and the second part 420 jointly form the shielding area. The corresponding flat portion 402 jointly form the connection area. The raised portion 401 covers the corresponding cable 30 and is electrically connected to the shielding layer 320. Each of the upper grounding part and the lower grounding part has four raised portions 401, and each raised portions 401 accommodates a corresponding cable. A plurality of tabs 241 are integrally stamped form the connecting portion 240. The grounding member 40 has a plurality of holes 441 that match the corresponding tabs 241. The hole 441 is provided on the flat portion 402. Each of the tabs 241 passes through the corresponding hole 441 and is soldered to the grounding member 40. The grounding member 40, the shielding layer 320 of the cable 30, the connecting portion 240 and the grounding terminal 204 are electrically connected together to form a common ground, which move the crosstalk to a higher frequency, reduce the crosstalk within the operating frequency, and improve the signal transmission performance of the high-speed terminal module to ensure effective signal transmission.

The electrical connector assembly 900 further includes a mounting member 50 disposed on the transfer terminals 207. The mounting member 50 is convenient for the mounting feet 271 to be pressed and installed on the external circuit board. The mounting member 50 includes a fixing part 501 fixed to the transfer terminal 207, a pressing part 502 extending upward from the fixing part 501, and a retaining part 503 extending from the left and right sides of the fixing part 501. The mounting member 50 is assembled at the rear of the horizontal part 275 and the upper part of the vertical part 273. The mounting member 50 is located on the upper part of the positioning member 260. An external force may be applied to the upper surface 504 of the pressing part 502, and the mounting member 50 can transmit the external force to the positioning member 260 so that the mounting feet 271 of the transfer terminal 207 can be mounted to the external circuit board. The mounting member 50 includes a front mounting member 510 and a rear mounting member 520. The front mounting member 510 includes terminal holes 515 for each of the horizontal portions 275 to pass through, grooves 516 for accommodating the corresponding vertical portions 273 of the front row, and grids 517 spaced apart from the grooves 516. The front surface of the vertical portion 273 of the front row abuts the bottom surface of the groove 516. The front surface of the vertical portion 273 of the rear row abuts the rear surface of the grid 517. The mounting member 50 is located on the rear exterior of the insulative housing 10 to facilitate the application of force.

The electrical connector assembly 900 further includes a metal retainer 60 for fixing the upper terminal module 21 and the lower terminal module 22. The metal retainer 60 is a one-piece structure. The metal retainer 60 includes a bottom wall 610 and two side walls 620 protruding upward from the bottom wall 610. The bottom wall 610 has an opening 611 for all the mounting feet 271 to pass through. The positioning member 260 is received in the opening 611. The front positioning member 261 and the rear positioning member 262 are partially staggered in the transverse direction. The contour shape of the opening 611 matches the cross-sectional shape of the front positioning member 261 and the rear positioning member 262. In other embodiments, the metal retainer 60 can also be replaced with other non-metallic materials.

The electrical connector assembly 900 further includes an upper molding block 710 integrally formed on the cable 30 connected to the upper terminal module 21, and a lower molding block 720 integrally formed on the cable 30 connected to the lower terminal module 22. The rear insulator 250, the mounting member 50, the upper molding block 710 and the lower molding block 720 are all matched with the metal retainer 60. The outer side wall of each rear insulator 250 includes a plurality of bumps 251 and an installation space 252 located between adjacent bumps 251. Each of the side walls 620 of the metal retainer 60 includes a plurality of protruding pieces 621 and spacing spaces 622 between the protruding pieces 621. The protruding piece 621 is inserted into the corresponding installation space 252 and interferes with the bump 251. An installation gap 253 is formed on the insulator 250. The front and rear sides of the protruding piece 621 are held in the installation gap 253. The retaining parts 503 of the front mounting member 510 and the rear mounting member 520 are jointly received in a same spacing space 622 of the metal retainer 60 along the front and rear directions. The upper molding block 710 and the lower molding block 720 are aligned in the up and down direction and are accommodated together in a same spacing space 622.

The electrical connector assembly 900 of the present invention includes a connecting portion 240 that connects the ground terminals 204 together, and a grounding member 40 that is electrically connected to the connecting portion 240. The grounding member 40 is electrically connected to the corresponding shielding layer 320 of the cable 30 and circumferentially surrounds each of the signal core wire pairs 310, has good anti-interference and grounding effects, improves the transmission performance of the signal terminal, and ensures effective signal transmission.

The electrical connector assembly 900 fixes the upper terminal module 21 and the lower terminal module 22 together through the metal retainer 60, so that the electrical connector assembly 900 has a compact structure and is easy to assemble. The bottom wall of the metal retainer 60 is provided with openings for all mounting feet 271 to pass through, and to position the upper and lower circuit board mounting terminals, resulting in higher assembly accuracy.

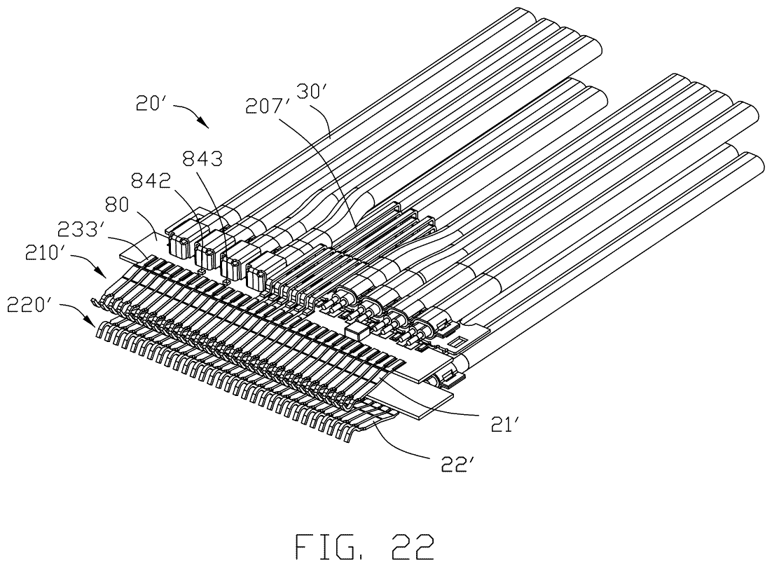

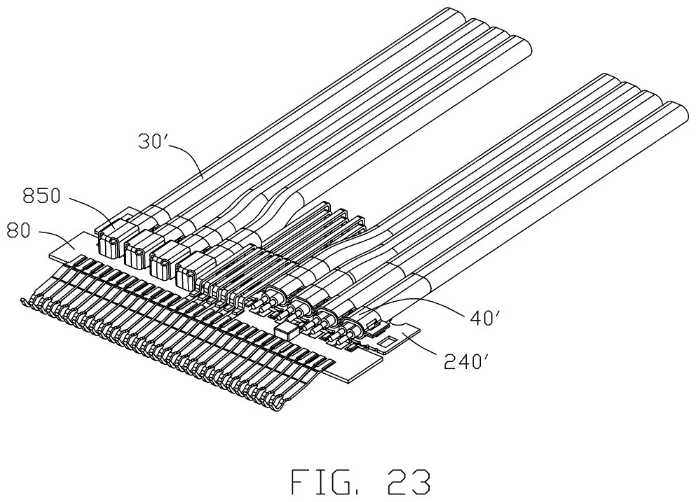

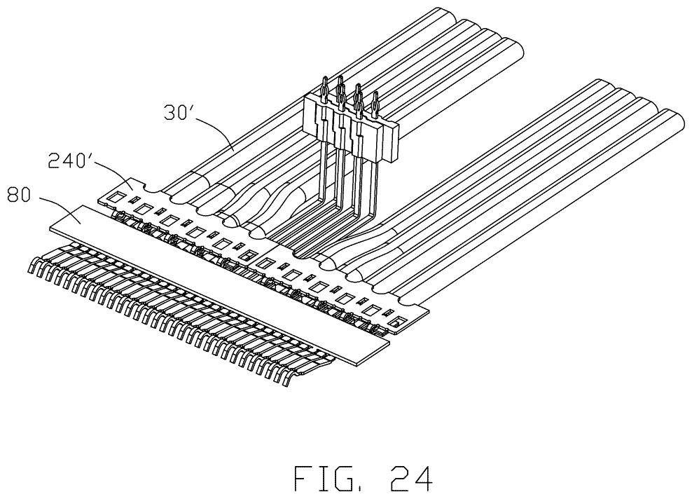

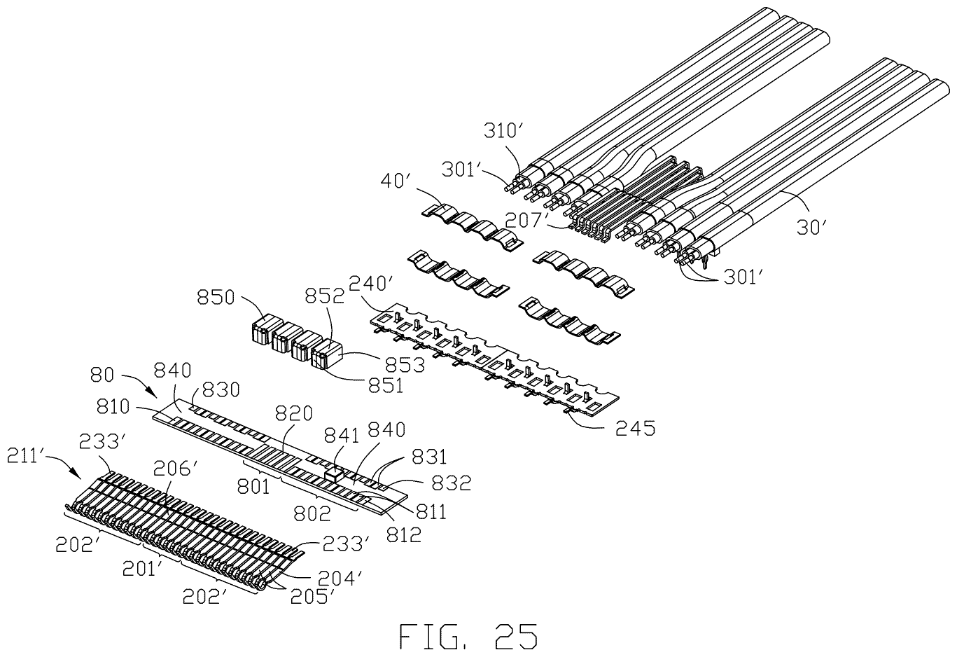

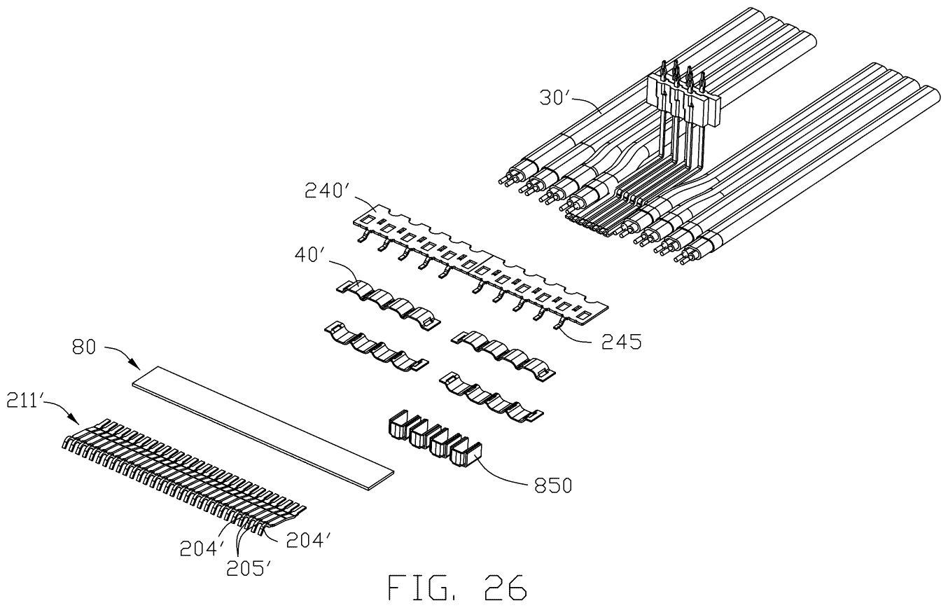

FIGS. 22-26 show another embodiment of the terminal module, with some structures omitted. In this embodiment, the first terminal module 210′ of the upper terminal module 21′, the second terminal module 220′ of the lower terminal module 22′, the cable 30′ and the transfer terminal 207′ are exactly the same as those in the first embodiment. The difference is that the cable 30′ and the transfer terminal 207′ are not directly connected to the corresponding tail portion 233′ of the terminal, but are connected through the middle printed circuit board 80. Since the lower terminal module 22′ is similar to the upper terminal module 21′, in this embodiment, only the upper terminal module 21′ is introduced. Each tail portion 233′ of the first row of terminals 211′ of the upper terminal module 21′ is mechanically and electrically connected to the printed circuit board 80. Each inner conductor 301′ of the cable 30′ is also mechanically and electrically connected to the printed circuit board 80. In this way, a pair of inner conductors 301′ is electrically connected to a pair of signal terminals 205′ through the printed circuit board 80. Specifically, the printed circuit board 80 includes a sideband area 801 corresponding to the sideband terminal area 201′ and a high-speed area 802 corresponding to the high-speed terminal area 202′. The high-speed area 802 includes a plurality of front conductive pads 810 arranged in a transverse direction in a front area, a plurality of rear conductive pads 830 arranged in a transverse direction in a rear area, and a middle area 840 located therebetween. The size of the printed circuit board 80 in the front-rear direction is smaller than the size of the first row of terminals 211′ in the front-rear direction. The size of the middle area 840 in the front-rear direction is no greater than the sum of the sizes of the front conductive pad 810 and the rear conductive pad 830 in the front-rear direction. The front conductive pads 810 includes a plurality of front ground conductive pads 812 and pairs of front signal conductive pads 811 arranged alternately with the front ground conductive pads 812. The rear conductive pads 830 includes plurality of rear ground conductive pads 832 and pairs of rear signal conductive pads 831 arranged alternately with the rear ground conductive pads 832. The tail portions 233′ of a pair of signal terminals 205′ is in contact with the corresponding pair of front signal conductive pads 811. A pair of inner conductors 301′ of the cable 30′ is in direct contact with the corresponding pair of rear signal conductive pads 831. The electrical connector assembly further includes an IC 841 disposed in the middle area 840 of the printed circuit board 80 for optimizing SI, and a resistor 842 or/and capacitor 843 disposed in the middle area 840 of the printed circuit board 80 for adjusting impedance.

The electrical connector assembly 900 further includes a plurality of metal shielding frames 850 mounted on the printed circuit board 80. Each metal shielding frame 850 covers the front of a corresponding pair of signal core wires 310′ to shield crosstalk. The metal shielding frame 850 is formed by bending one piece of metal material. The metal shielding frame 850 includes a front wall 851, an upper wall 852 and two side walls 853. The metal shielding frame 850 completely covers the exposed inner conductors 301′ of a corresponding pair of signal core wires 310′ in the front-to-back direction. The bottom of the front wall 851 of the metal shielding frame 850 is located in the middle area 840 of the printed circuit board 80. The bottom of the side walls 853 extends rearward beyond the rear edge of the printed circuit board 80. The metal shielding frame 850 and the printed circuit board 80 cooperate to surround the pair of signal core wires 310′ in five directions. The sideband area 801 includes a plurality of sideband conductive pads 820. Each sideband terminal 206′ and the corresponding transfer terminal 207′ are electrically connected through the printed circuit board 80. The tail of a sideband terminal 206′ and the front of the corresponding transfer terminal 207′ are mechanically connected to one same sideband conductive pad 820. In other embodiments, the printed circuit board 80 can also be other conductive intermediate conductors, such as flexible circuit boards, etc. Compared with the first embodiment, in this embodiment, the connecting portion 240′ electrically connects a plurality of ground terminals 204′ through the printed circuit board 80. Specifically, the connecting portion 240′ has a plurality of contact fingers 245 extending forward. Each of the contact fingers 245 is welded or soldered to the corresponding rear ground conductive pads 832 on the printed circuit board 80, the tail of the ground terminal 204′ is welded or soldered to the front ground conductive pad 812. In this embodiment, the grounding member 40′ is the same as that in the first embodiment, and the grounding member 40′ is provided on the rear side of the metal shielding frame 850.

The electrical connector assembly 900 of the present invention is transferred through the printed circuit board 80, so that there is space between the wires and the terminals for SI optimization and a structure for controlling crosstalk, such as setting up a metal shielding frame 850 to shield crosstalk. Without printed circuit board 80, it would be difficult to make adjustments at this location. And electronic components such as ICs, capacitors, and resistors can be placed on the printed circuit board to optimize the circuit design.

The electrical connector assembly 900 of the present invention conforms to the specification of OSFP, which defines eight transmitting channels and eight receiving channels, the signal transmission rate of each channel can reach 50 Gbps or above. Of course, the present invention can also be applied to high-speed electrical connector assembly such as SFP-DD, SFP, QSFP-DD, etc.

1. An electrical connector assembly comprising:
an insulative housing having a front mating slot and a rear receiving space;
a terminal module received in the insulative housing, the terminal module includes a plurality of terminals arranged in a transverse direction, each of the plurality of terminals including a mating portion and a tail portion;
a cable electrically connected to the terminal module and extending backward out of the insulative housing; and
an intermediate conductor connecting the terminal module and the cable; wherein
the plurality of terminals includes a high-speed terminal area and a sideband terminal area, the terminals in the high-speed terminal area include a plurality of ground terminals and signal terminal pairs arranged between adjacent ground terminals, the cable includes pairs of signal core wires and a shielding layer covering each pair of signal core wires, each of the signal core wires includes an inner conductor and an inner insulation layer covering the inner conductor, and the inner conductors of a pair of signal core wires are electrically connected to the tail portions of a corresponding pair of signal terminals through the intermediate conductor.

2. The electrical connector assembly as claimed in claim 1, wherein the intermediate conductor is a printed circuit board.

3. The electrical connector assembly as claimed in claim 2, wherein the size of the circuit board in a front-rear direction is smaller than the size of the terminal in the front-rear direction.

4. The electrical connector assembly as claimed in claim 2, wherein the circuit board includes a high-speed area corresponding to the high-speed terminal area, the high-speed area includes a plurality of front conductive pads arranged in a transverse direction in a front area of the printed circuit board, a plurality of rear conductive pads arranged in a transverse direction in a rear area, and a middle area located therebetween, the size of the middle area in the front-rear direction is no greater than the sum of the sizes of a front conductive pad and a rear conductive pad in the front-rear direction.

5. The electrical connector assembly as claimed in claim 4, wherein the plurality of the front conductive pads includes a plurality of front ground conductive pads and pairs of front signal conductive pads arranged alternately with the front ground conductive pads, the plurality of rear conductive pads includes a plurality of rear ground conductive pads and pairs of rear signal conductive pads arranged alternately with the rear ground conductive pads, wherein the tail portions of a pair of signal terminals is in contact with a corresponding pair of front signal conductive pads, and the inner conductors of a pair of signal core wires is in direct contact with the corresponding pair of rear signal conductive pads.

6. The electrical connector assembly as claimed in claim 5, wherein further including an IC disposed in the middle area of the circuit board to optimize SI.

7. The electrical connector assembly as claimed in claim 5, further including a resistor or/and a capacitor disposed in the middle area of the circuit board for adjusting impedance.

8. The electrical connector assembly as claimed in claim 5, further including a plurality of metal shielding frames mounted on the circuit board, each of the metal shielding frames covering the front of a corresponding pair of signal core wires to shield crosstalk.

9. The electrical connector assembly as claimed in claim 8, wherein the metal shielding frame is formed by bending one piece of metal material.

10. The electrical connector assembly as claimed in claim 9, wherein the metal shielding frame includes a front wall, an upper wall and two side walls, wherein the metal shielding frame completely covers the exposed inner conductor of the corresponding pair of signal core wires in the front-rear directions.

11. The electrical connector assembly as claimed in claim 10, wherein the bottom of the front wall of the metal shielding frame is located in the middle area of the circuit board, and the bottom of the side walls extends backward beyond the rear edge of the circuit board.

12. The electrical connector assembly as claimed in claim 5, further including a connecting portion electrically connecting a plurality of ground terminals in series through the circuit board.

13. The electrical connector assembly as claimed in claim 12, wherein the connecting portion has a plurality of contact fingers extending forward for direct contact with the corresponding rear ground conductive pads on the circuit board, and the tail portions of the ground terminals are in direct contact with the corresponding front ground conductive pads.

14. The electrical connector assembly as claimed in claim 13, further including a grounding member disposed on a rear side of the metal shielding frame.

15. The electrical connector assembly as claimed in claim 14, wherein the grounding member includes an upper grounding part and a lower grounding part that cooperates with the upper grounding part, each of the upper grounding part and the lower grounding part including at least two raised portions covering the cable and a flat portion connected to adjacent raised portions, and the raised portions of the upper and lower grounding parts cooperate to circumferentially surround the exposed shielding layer of each pair of signal core wires and are electrically connected to a corresponding shielding layer.

16. The electrical connector assembly as claimed in claim 15, wherein the connecting portion has a plurality of tabs, and the grounding member has a number of holes that are mechanically and electrically connected to the corresponding tabs.

17. The electrical connector assembly as claimed in claim 16, wherein each of the upper grounding part and the lower grounding part has four raised portions.

18. The electrical connector assembly as claimed in claim 14, further including a transfer terminal for mounting on an external circuit board, the sideband terminal area includes a plurality of sideband terminals, and each sideband terminal is electrically connected to a corresponding transfer terminal through the circuit board.

19. The electrical connector assembly as claimed in claim 18, wherein the circuit board further includes a sideband area including a plurality of sideband conductive pads, the tail portion of a sideband terminal and the front of the corresponding transfer terminal are mechanically connected to a same sideband conductive pad.

20. An electrical connector assembly comprising:
an insulative housing having a front mating slot and a rear receiving space;
an upper terminal module including a first row of terminals arranged in a transverse direction;
a lower terminal module including a second row of terminals arranged along the transverse direction;
a cable electrically connected to the upper terminal module and the lower terminal module; and
an intermediate circuit board; wherein
each terminal of the first row of terminals and the second row of terminals includes a mating portion and a tail portion, the mating portions of the first row of terminals and the second row of terminals are respectively arranged on the upper and lower sides of the mating slot to cooperate with a mating connector, each of the first row of terminals and the second row of terminals includes a plurality of ground terminals and signal terminal pairs arranged between adjacent ground terminals, the cable includes a pair of spaced apart inner conductors and an inner insulation layer covering the inner conductors, and the tail portions of a signal terminal pairs and the front end of the pair of inner conductor are both mechanically and electrically connected to the circuit board.
